(19) United States
(12) Patent Application Publication
(10) Pub. No.: US 2016/0052241 A1
(43) Pub. Date: Feb. 25, 2016

(54) LARGE THIN GLASS/METAL LAMINATES

(71) Applicant: Corning Incorporated, Corning, NY (US)

(72) Inventor: Chunhe Zhang, Horseheads, NY (US)

(21) Appl. No.: 14/828,583

(22) Filed: Aug. 18, 2015

Related U.S. Application Data
(60) Provisional application No. 62/039,548, filed on Aug. 20, 2014.

(51) Int. Cl. B32B 17/10; B32B 37/14; B32B 15/04

(52) U.S. Cl. CPC B32B 17/10761; B32B 17/10018; B32B 15/04; B32B 17/10064; B32B 17/10137; B32B 17/10091; B32B 17/101; B32B 17/10146; B32B 37/14; B32B 2509/10; B32B 2509/00; B32B 2307/40; B32B 2479/00; B32B 2309/105

(57) ABSTRACT

Disclosed herein are laminated structures comprising a metal sheet including a first face and a second face, a first glass sheet, and a first interlayer attaching the first glass sheet to the first face of the metal sheet. Also disclosed herein are methods of manufacturing a laminated structure comprising the steps of laminating a metal sheet and a glass sheet together with an interlayer.

### CROSS-REFERENCE TO RELATED APPLICATIONS

This application claims the benefit of priority under 35 U.S.C. §119 of U.S. Provisional Application Ser. No. 62/039,548 filed on Aug. 20, 2014 the content of which is relied upon and incorporated herein by reference in its entirety.

### FIELD OF THE DISCLOSURE

Disclosed herein are glass/metal laminate structures and methods of manufacturing laminate structures and, more particularly, large glass/metal laminate structures including a chemically strengthened or non-chemically strengthened glass sheet.

### BACKGROUND

A variety of apparatuses, such as appliances, may comprise an outer housing including a metal sheet. For example, a relatively thin metal sheet can be used as an outer housing surface for an appliance such as a refrigerator and/or freezer. Other non-limiting applications include architectural elements, e.g., elevator wall panels, room walls, and office cubicle walls; furniture applications, such as furniture panels; and decorative or functional applications, such as marker boards, to name a few. The metal sheet may be used to provide protection to the appliance or element while also maintaining its outer appearance. However, it has been observed that the metal sheet may lose its aesthetic appearance over time due to poor scratch resistance and/or cleaning difficulties, for example, with respect to fingerprints and/or oil smudges. Accordingly, it would be advantageous to provide a metal sheet with a protective skin, such as a thin glass/metal laminated structure, which can be more easily cleaned and/or which may have increased scratch resistance.

Applicant has disclosed thin metal/glass laminates having various desirable properties, for instance in International Patent Application No. PCT/US2013/062956, filed on Oct. 2, 2013, and U.S. application Ser. No. 14/183,185, filed on Feb. 18, 2014, which are incorporated herein by reference in their entireties. However, Applicant has discovered that warping can occur in larger glass/metal laminates (e.g., about 300 mm×300 mm or greater), which can, in some instances, render the manufactured article unsuitable for the intended application. It would therefore be advantageous to provide thin glass/metal laminates for larger applications which can provide the improved aesthetic properties discussed herein without the potential drawback of warping.

### SUMMARY

The disclosure relates, in various embodiments, to a laminated structure comprising a metal sheet having a first face and a second face with a thickness ranging from about 0.1 mm to about 5 mm extending between the first face and the second face. The laminated structure further includes a first glass sheet having a thickness ranging from about 0.1 mm to about 2.5 mm, and a first interlayer attaching the first glass sheet to the first face of the metal sheet. The metal sheet can have a coefficient of thermal expansion (CTE) which is within about 30% of a CTE of the glass sheet.

In certain embodiments, the first glass sheet may have a thickness ranging from about 0.1 mm to about 1.5 mm, from about 0.5 to about 1.1 mm, or from about 0.3 mm to about 1 mm, including all ranges and subranges therebetween. The first glass sheet may, in various embodiments, be treated, e.g., chemically strengthened and/or thermally tempered, and may comprise a glass selected from aluminosilicate, alkali-aluminosilicate, borosilicate, alkali-borosilicate, aluminoborosilicate, and alkali-aluminoborosilicate glasses. The first glass sheet may also comprise, by way of non-limiting example, an anti-glare surface which may be obtained, for instance, by etching-based and/or sol-gel deposition processes.

According to other non-limiting embodiments, the first interlayer may comprise polyvinyl butyral or an ionomer. The first interlayer may, in various embodiments, have a thickness ranging from about 0.1 mm to about 2 mm, such as from about 0.1 mm to about 0.8 mm. In further embodiments, the first interlayer may have a Young's modulus of greater than or equal to 15 MPa, such as greater than or equal to 275 MPa.

The disclosure also relates to a method of manufacturing a laminated structure comprising: (i) providing a metal sheet having a first face and a second face and a thickness ranging from about 0.1 mm to about 5 mm extending between the first face and the second face, (ii) providing a glass sheet having a thickness ranging from about 0.1 mm to about 2.5 mm, and (iii) attaching the glass sheet to the first face of the metal sheet with a first interlayer, wherein a CTE of the metal sheet is within about 30% of a CTE of the glass sheet.

Additional features and advantages will be set forth in the detailed description which follows, and in part will be readily apparent to those skilled in the art from that description or recognized by practicing the methods described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding, and are incorporated into and constitute a part of this specification. The drawings illustrate various non-limiting embodiments and together with the description serve to explain the principles and operations of the disclosure.

### BRIEF DESCRIPTION OF THE DRAWINGS

Various features, aspects and advantages of the present disclosure are better understood when the following detailed description is read with reference to the accompanying drawings wherein like structures are indicated with like reference numerals when possible, in which:

FIG. 1 is a cross sectional view illustrating an exemplary laminated structure in accordance with aspects of the disclosure;

FIG. 2 is a cross-sectional view illustrating an exemplary laminated structure in accordance with further aspects of the disclosure; and

FIG. 3 is a flow chart illustrating exemplary steps of manufacturing laminated structures in accordance with aspects of the disclosure.

### DETAILED DESCRIPTION

Laminated structures may be used in a wide range of applications in accordance with aspects of the disclosure. For example, laminated structures may be used in various architectural applications such as siding, decorative panels, cabinet installations, wall coverings, or other architectural applications. In further examples, the laminated structures may be used for furniture items and/or household appliances. For instance, the laminated structures may be incorporated as outer panels for a cabinet, furniture item, and/or household appliance. In one non-limiting embodiment, the laminated structures can be incorporated into a cabinet, such as a refrigerated cabinet, e.g., a refrigerator or freezer, although various other non-refrigerated examples may be alternatively provided.

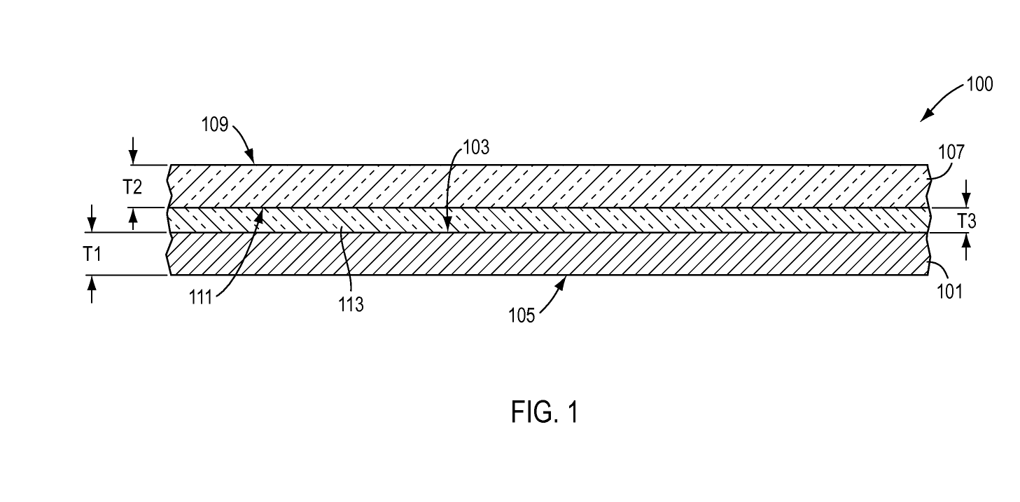

FIG. 1 illustrates a cross sectional view of a laminated structure 100 according to various aspects of the disclosure. The laminated structure can include a metal sheet 101 that can comprise a wide range of metal types and/or a wide range of thicknesses and configurations. For instance, the metal sheet 101 can comprise steel, cold rolled steel, aluminum, or any other suitable metal. In one non-limiting example, the metal sheet comprises stainless steel. Stainless steel may be suitable for outer panel constructions which can provide desired protection, resistance to corrosion, and/or a desired outer appearance, such as a brushed stainless steel appearance. Commercially available stainless steel suitable for use according to various aspects of the disclosure can include, for instance, 430# stainless steel and other stainless steels with a similar coefficient of thermal expansion (CTE), such as 409#, 410#, 416#, 430#, 440#, and 446# stainless steels, to name a few.

The metal sheet 101 can include a first face 103 and a second face 105 with a thickness T1 extending between the first face 103 and the second face 105. The thickness T1 of the metal sheet 101 may vary depending on the particular application. Relatively thin metal sheets can be used in various applications, for example, to reduce material costs and/or weight of the laminated structure while still providing sufficient resistance to deformation. In further embodiments, relatively thick metal sheets may be used in various applications, for example, where further support is desired to maintain the mechanical integrity of the laminated structure. In some embodiments, the thicknesses may range from a 25 Gauge metal sheet (e.g., about 0.5 mm) up to a 12 Gauge metal sheet (e.g., about 2 mm). In further embodiments, the thicknesses may range from a 24 Gauge metal sheet (e.g., about 0.64 mm thick stainless steel) up to a 16 Gauge metal sheet (e.g., about 1.59 mm thick stainless steel). According to another non-limiting embodiment, a 26 Gauge metal sheet (e.g., about 0.48 mm) may be used. As such, referring to FIG. 1, the thickness T1 of the metal sheet 101 may range from about 0.1 mm to about 5 mm, such as from about 0.3 mm to about 2 mm, from about 0.5 to about 1.5 mm, or from about 0.6 mm to about 1 mm, although other thicknesses may be provided depending on the particular application.

The metal sheet 101 can, in various embodiments, have a CTE that is within about 30% of the CTE of the glass sheet 107, such as within about 25%, within about 20%, within about 15%, within about 10%, within about 5%, or within about 1% of the CTE of the glass sheet. As used herein, the term “within about 30%” and variations thereof is intended to denote that the CTE of the metal sheet has a value that can range from as low as 30% less than the CTE of the glass sheet (0.7*CTE_{glass}) to as high as 30% greater than the CTE of the glass sheet (1.3*CTE_{glass}). For example, the CTE of the metal sheet may be less than about 11×10⁻⁶/° C., such as less than about 10×10⁻⁶/° C., less than about 9×10⁻⁶/° C., or less than about 8×10⁻⁶/° C., including all ranges and subranges therebetween. In certain non-limiting embodiments, the CTE of the metal sheet can range from about 7.5×10⁻⁶/° C. to about 11×10⁻⁶/° C., such as from about 8×10⁻⁶/° C. to about 10.5×10⁻⁶/° C., or from about 8.5×10⁻⁶/° C. to about 9.5×10⁻⁶/° C., including all ranges and subranges therebetween.

As illustrated in FIG. 1, the laminated structure can further include a glass sheet 107 having a thickness T2 extending between a first glass face 109 and a second glass face 111 of less than or equal to about 2.5 mm, such as less than or equal to about 2 mm, or less than or equal to about 1.5 mm, for example, ranging from about 0.1 mm to about 1.5 mm, from about 0.5 to about 1.1 mm, or from about 0.3 mm to about 1 mm, including all ranges and subranges therebetween. In one non-limiting embodiment, the glass sheet 107 can have a thickness T2 of about 0.7 mm. In another embodiment, the glass sheet 107 can have a thickness T2 of about 1 mm. In a further embodiment, the glass sheet 107 can have a thickness T2 of about 0.3 mm. According to still further embodiments, the glass sheet 107 can have a thickness T2 ranging from about 0.1 mm to about 0.5 mm, or from about 0.3 mm to about 1 mm.

The glass sheet 107 may comprise, according to various embodiments, a glass such as an aluminosilicate, alkali-aluminosilicate, borosilicate, alkali-borosilicate, aluminoborosilicate, and alkali-aluminoborosilicate glass, or other glass material. Various glass forming techniques may be used to produce glass sheets 107 that may be incorporated within the laminated structure. For instance, fusion down draw techniques, fusion updraw techniques, slot draw techniques or other processes may be used to provide a glass ribbon that may be processed into glass sheets having the desired dimensional configuration. For example, a fusion draw process can be provided to obtain a substantially pristine surface.

In some embodiments, display quality glass sheets 107 may be used to provide a transparent covering over the first face 103 of the metal sheets 101. Providing display quality glass can allow the aesthetic appearance of the first face 103 of the metal sheets 101 to be preserved. At the same time, the glass sheet 107 can help maintain the pristine surface quality of the first face 103 of the metal sheet 101. Indeed, scratches, smudging and/or other imperfections may be avoided by covering the metal sheet 101 with the protective glass sheet 107.

The glass sheet can have a coefficient of thermal expansion (CTE) ranging, for example, from about 5×10⁻⁶/° C. to about 14×10⁻⁶/° C., such as from about 6×10⁻⁶/° C. to about 13×10⁻⁶/° C., from about 7×10⁻⁶/° C. to about 12×10⁻⁶/° C., from about 8×10⁻⁶/° C. to about 11×10⁻⁶/° C., or from about 9×10⁻⁶/° C. to about 10×10⁻⁶/° C., including all ranges and subranges therebetween. In certain embodiments, the glass sheet can have a CTE ranging from about 7×10⁻⁶/° C. to about 9×10⁻⁶/° C., for instance, ranging from about 7.5×10⁻⁶/° C. to about 8.6×10⁻⁶/° C., from about 7.6×10⁻⁶/° C. to about 8.5×10⁻⁶/° C., or from about 8×10⁻⁶/° C. to about 8.3×10⁻⁶/° C.

According to further aspects, the glass sheet can have a compressive stress greater than about 100 MPa and a depth of layer of compressive stress (DOL) greater than about 10 microns, for example, a compressive stress greater than about 500 MPa and a DOL greater than about 20 microns, or a compressive stress greater than about 700 MPa and a DOL greater than about 40 microns. The glass sheet can, in some embodiments, be treated, e.g., chemically strengthened and/or thermally tempered, to increase the strength of the glass and/or its resistance to breakage and/or scratching.

In one embodiment, the glass sheet 107 can comprise chemically strengthened glass such as Corning® Gorilla® glass from Corning Incorporated. Such chemically strengthened glass, for example, may be provided in accordance with U.S. Pat. Nos. 7,666,511, 4,483,700, and/or 5,674,790, which are incorporated herein by reference in their entireties. In certain non-limiting embodiments, the glass sheet can be Corning® Gorilla® glass having a CTE ranging from about 7.5 to about 8.5×10⁻⁶/° C. Corning® Willow™ glass and Corning® EAGLE XG® glass from Corning Incorporated may also be suitable for use as the glass sheet in various embodiments.

According to non-limiting aspects of the disclosure, chemical strengthening may be carried out by an ion exchange process. For instance, a glass sheet (e.g., aluminosilicate glass, alkali-aluminoborosilicate glass) may be made by fusion drawing and then chemically strengthened by immersing the glass sheet in a molten salt bath for a predetermined period of time. Ions within the glass sheet at or near the surface of the glass sheet are exchanged for larger metal ions, for example, from the salt bath. The temperature of the molten salt bath and treatment time period will vary; however, it is within the ability of one skilled in the art to determine the time and temperature according to the desired application. By way of non-limiting example, the temperature of the molten salt bath may range from about 430° C. to about 450° C. and the predetermined time period may range from about 4 to about 8 hours.

Without wishing to be bound by theory, it is believed that the incorporation of the larger ions into the glass strengthens the sheet by creating a compressive stress in a near surface region. A corresponding tensile stress is induced within a central region of the glass sheet to balance the compressive stress. The chemical strengthening process of Corning® Gorilla® glass can have a relatively high compressive stress (e.g., from about 700 MPa to about 730 MPa; and even capable of greater than 800 MPa) at a relatively high DOL (e.g., about 40 microns; and even capable of greater than 100 microns). Such glass can have a high retained strength and high resistance to scratch damage, high impact resistance, and/or high flexural strength as well as a substantially pristine surface. One exemplary glass composition may comprise SiO₂, B₂O₃ and Na₂O, wherein (SiO₂+B₂O₃) 66 mol %, and Na₂O 9 mol %.

In further embodiments, the glass sheet 107 may be acid-etched to further strengthen the glass sheet. Acid etching of the glass sheet may enable use of even thinner metal in the laminated structure of the disclosure without deterioration in impact performance. The acid etching step, in some examples, can remove from about 1.5 to about 1.7 microns from one or more of the surfaces of the glass sheet 107. Acid etching addresses the fact that glass strength can be extremely sensitive to the size and the tip shape of surface flaws. By removing the above-mentioned surface layer, it is believed that the acid etching can clear away a majority of surface flaws smaller than 1 micron. While acid etching may not remove larger flaws, the acid etching procedure can round the flaw tip which could otherwise dramatically decrease the stress concentration factor.

The improvement of the glass surface by acid etching (e.g., removal of small surface flaws and rounding the tips of larger flaws) can dramatically increase glass strength, such as impact resistance. Moreover, only a relatively small depth of glass may be removed, such that a significant compressive stress drop in the glass sheet may not occur, as the glass can have a relatively high compressive stress at a much larger depth, such as 40 microns from the surface, or even greater than 100 microns in some examples.

In one non-limiting embodiment, the acid etching step can be conducted on a horizontal spray etching system, with a chemical solution of about 1.5M HF/0.9M H₂SO₄. The other process parameters can include one or more of a process temperature of about 90° F. (32.2° C.), a process time of about 40 seconds, a spray pressure of about 20 psi, a spray oscillation of about 15 cycles per minute, and approximately 0.48 gallon-per-minute conical spray nozzles. However, it is possible to vary one or more of the above process parameters depending on the particular application and such variations are within the ability of one skilled in the art. After acid etching, the processed glass sheets may be cleaned with a rinse step, e.g., using water. For example, approximately 0.3 gallon-per-minute fanjet pattern nozzles may be used at a spray pressure of about 20 psi. The acid-etched glass sheets may then be dried. For instance, an air flow dryer system may be employed, such as an air turbine operating at approximately 5 hp.

As illustrated in FIG. 1, the laminated structure can further include an interlayer 113 attaching the first glass sheet 107 to the first face 103 of the metal sheet 101. The interlayer 113 can be formed from a wide range of materials depending on the application and the characteristics of the glass and metal sheets. According to certain embodiments, an optically clear interlayer can be provided that is substantially transparent, although opaque and possibly colored interlayers may be provided in further examples. In other embodiments, desirable images can be printed, for example, by screen printing or digital scanning printing, onto the glass and/or onto the interlayer for aesthetic and/or functional purposes. Because these printed images can be arranged on the interface (e.g., on the interlayer and/or the interior glass surface), they can be well preserved from scratch damages during the product lifetime.

In addition or alternatively, the interlayer may comprise a transparent layer to allow clear viewing of the outer surface of the metal sheets. Indeed, the interlayer 113 can comprise a transparent interlayer 113 that can provide an excellent optical interface between the glass sheet 107 and metal sheet 101. In some embodiments a display-quality glass sheet 107 may be laminated to the metal sheet 101 by a transparent interlayer 113 so that the outer appearance of the first face 103 of the metal sheet 101 may be easily viewed and preserved over time.

Still further, the interlayer 113 can be selected to help strengthen the laminated structure and can further help arrest glass pieces from the glass sheet 107 in the event that the glass sheet 107 shatters. The interlayer can comprise various materials such as ethylene vinyl acetate (EVA), thermoplastic polyurethane (TPU), Polyester (PET), acrylic (e.g., acrylic pressure sensitive adhesive tape), polyvinyl butyral (PVB), SentryGlas® ionomer, or any other suitable interlayer material. If PET is used, in one embodiment, the PET material can be sandwiched between two layers of acrylic adhesive material. In another non-limiting embodiment, the interlayer 113 can be selected to provide a Young's modulus greater than or equal to 15 MPa (such as greater than or equal to about 30 MPa, about 50 MPa, about 100 MPa, about 150 MPa, or about 200 MPa). For instance, the interlayer 113 may comprise polyvinyl butyral having a thickness ranging from about 0.1 mm to about 0.8 mm, or from about 0.3 mm to about 0.76 mm, such as about 0.38 mm.

In a further embodiment, the interlayer 113 can comprise a Young's modulus of greater than or equal to 275 MPa. For example, the first interlayer can include an ionomer with a Young's modulus of greater than or equal to 275 MPa (such as greater than or equal to about 300 MPa, about 350 MPa, or about 400 MPa). In various embodiments, the ionomer can comprise SentryGlas® ionomer available from DuPont. In such embodiments, the thickness of the interlayer 113 can range, for example, from about 0.1 mm to about 2 mm, such as from about 0.5 mm to about 1.5 mm, such as about 0.89 mm.

According to further aspects of the disclosure, the laminated structures can comprise one or more additional substrates, such as a sensor, indicator, or active device. For example, a touch pad and the associated electronics may be provided in an underlying substrate or may be provided in an intermediate interlayer whereupon a glass substrate can be provided directly adjacent to the touch pad. Due to the thinness of the glass sheet, a user can interface with the touch pad. For example, in the non-limiting exemplary embodiment of a refrigerator and/or freezer, the user can, e.g., activate a light, dispense water and/or ice, etc.

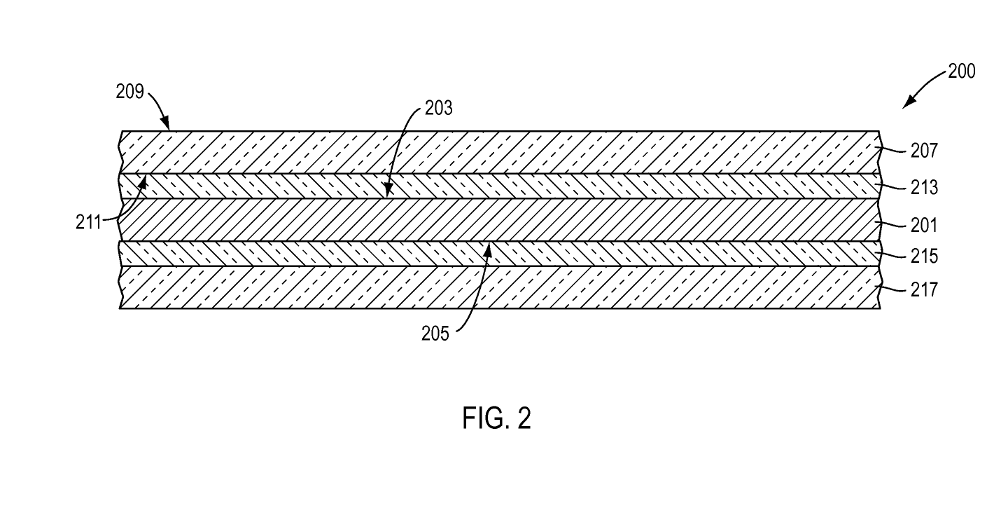

It is also to be understood that the laminated structures in accordance with the disclosure are not limited to structures comprising a single glass sheet and/or a single metal sheet. For example, the laminated structure can also include a second interlayer attaching a second glass sheet to the second face of the metal sheet. FIG. 2 illustrates an exemplary laminated structure 200 comprising two such glass sheets, in accordance with various aspects of the disclosure. The laminated structure 200 includes a first interlayer 213 attaching a first glass sheet 207 to the first face 203 of the metal sheet 201. As shown, the laminated structure 200 can also include a second interlayer 215 attaching a second glass sheet 217 to the second face 205 of the metal sheet 201. The second glass sheet 217 may, in certain embodiments, be a chemically strengthened glass sheet. The second interlayer 215 can, in certain embodiments, comprise the same material and have the same thickness T3 as the first interlayer 213. Likewise, the second glass sheet 217, in some embodiments, can be identical to the first glass sheet 207 including having the same thickness T2 and other features. The second glass sheet 217 can, in various embodiments, protect the second face 205 of the metal sheet 201 in the same way the first glass sheet 207 protects the first face 203 of the metal sheet 201. Of course, other combinations of layers and their respective features can be used to provide a wide array of configurations which are intended to fall within the scope of the disclosure.

Methods

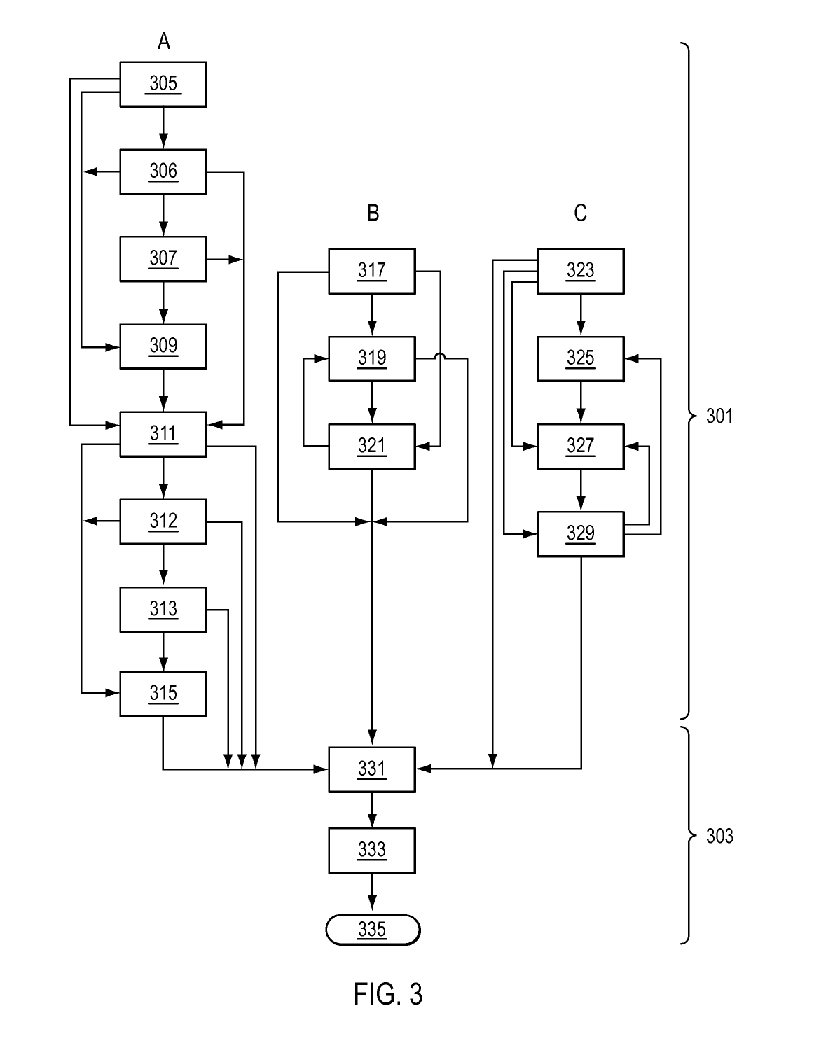

With reference to FIG. 3, exemplary methods of manufacturing the laminated structures in accordance with aspects of the disclosure will now be described. The methods can begin with step 301 including providing and/or preparing the glass sheet (see column A), interlayer (column B), and the metal sheet (Column C). As described below, the method includes a step 303 wherein the interlayer attaches the glass sheet to the first face of the metal sheet.

As shown in FIG. 3, column A demonstrates optional steps that may be carried out during a step of providing the glass sheet. The method of providing and/or preparing the glass sheet can include the step 305 of providing a glass sheet with a desired thickness (e.g., see T2 in FIG. 1). As mentioned previously, the thickness of the glass sheet can range from about 0.1 mm to about 2.5 mm. The glass sheet can comprise a glass such as an aluminosilicate, alkali-aluminosilicate, borosilicate, alkali-borosilicate, aluminoborosilicate, and alkali-aluminoborosilicate glass, or any other suitable glass material. The glass sheet can be provided by various techniques such as fusion down draw, fusion updraw, slot draw or other processes known in the art.

The glass sheet may be optionally processed in step 306 so as to provide the glass sheet with at least one anti-glare surface. Anti-glare processing may take place before (step 306) or after (step 312) the optional chemical strengthening step 311. For example, if the glass sheet undergoes anti-glare processing before the chemical strengthening step 311, etching-based anti-glare processes can be used. Non-limiting processes are described, for example, in European Patent Application Publication No. 2563733 A1 and International Application Publication No. WO 2012/0749343 A1, which are incorporated herein by reference in their entireties. Suitable etching-based anti-glare processes include, but are not limited to, acid etching, creamy etching, masked acid etching, mechanical roughening (e.g., sand blasting), and combinations thereof. In some non-limiting embodiments a combination of mechanical roughening and acid etching can be employed, although other combinations are envisioned. According to various embodiments, the anti-glare processing may take place before and/or after the shaping/sizing step 307.

The method can then optionally proceed from step 305 or 306 to step 307 of separating a plurality of glass sheets from a source glass sheet. For example, a glass ribbon of aluminosilicate glass or alkali-aluminoborosilicate glass may be formed from a fusion down draw process with the desired thickness. Then a plurality of glass sheets may be cut from the glass ribbon and optionally further separated into a subset of glass sheets having the overall desired dimensions for the particular application. Separating a plurality of glass sheets can be carried out with a wide range of techniques. For example, processing can be selected to minimize adverse effects to glass strength due to its risk in introducing extra flaws, especially for thin glass. In one example, an approximately 3 mm diameter scoring wheel with a tip angle of about 110°, e.g., including diamond, may be used for the scoring operation. Meanwhile, an applied force of approximately 0.8 kgf may be used for the scoring force.

The glass sheet having the desired size from step 307 may then be further optionally processed during step 309. For instance, it may be desirable to machine or otherwise finish at least one edge of the glass sheet prior to the step of chemically strengthening the glass sheet. For example, step 309 may include a step of edge grinding and finishing, e.g., to round or bevel the edge to the desired profile, to reduce sharp edges, and/or improve aesthetics and/or edge strength. In one embodiment, a profiled diamond wheel of 400# (mesh size of diamond abrasive) may be used in a wide variety of applications. Other processing parameters can include one or more of a grinding speed ranging from about 10 m/sec to about 30 m/sec, a feed rate of about 0.5 m/min, and a grinding depth ranging from about 0.1 mm to about 0.2 mm. If higher edge strength is desired, a subsequent grinding step may be carried out, for example, with an 800# diamond wheel. Such an optional subsequent grinding step can include similar processing parameters, for example, a grinding speed ranging from about 10 m/sec to about 30 m/sec, a feed rate of about 0.5 m/min, and a grinding depth ranging from about 0.05 mm to about 0.1 mm.

Once the desired size and properties are obtained and any edges are machined or otherwise finished (e.g., during steps 306, 307, and/or 309), the glass sheet may optionally be chemically strengthened during step 311. For example, as discussed above, the chemical strengthening step may comprise an ion exchange chemical strengthening technique, such as that used to generate Corning® Gorilla® glass. Still further, the glass sheet may be optionally acid etched during step 313. Acid etching may be carried out with exemplary procedures discussed above to further strengthen the glass sheets as desired for particular applications.

As discussed above, anti-glare processing, if performed, may also be carried out subsequent to the optional chemical strengthening step 311. For example, in step 312, the strengthened glass sheet may be subjected to sol-gel processing to produce at least one anti-glare surface. Non-limiting sol-gel processes are described, for example, in European Patent No. 1802557 B1, which is incorporated herein by reference in its entirety. Suitable sol-gel based anti-glare processes may also include, for example, coating the glass sheet with an anti-glare sol gel composition and baking the sheet at relatively low temperature (e.g., less than about 350° C.). According to various embodiments, subsequent to sol-gel anti-glare processing, the glass sheet can then be further processed by acid etching in step 313.

Optionally, before entering the lamination block 303 of the method, the glass sheet may be cleaned during step 315. Cleaning may be designed to remove surface dirt, stains, and other residues. The glass cleaning step can be conducted, e.g., with an industrial ultrasonic cleaner, a horizontal spray system, or other cleaning technique.

Many of the steps of column A are optional and may be even excluded altogether. For instance, the glass sheet may simply be provided for the process of laminating, excluding various processing steps described above. For example, after the step 305, the glass sheet may already include the desired thickness as well as the desired dimensions. In such an example, the method may proceed directly from step 305 to step 309 or may even proceed directly to step 311. If the provided glass sheet already exhibits the desired strength properties, the chemical strengthening step 311 and/or the acid etching step 313 may be skipped. Moreover, if the glass sheet is sized during step 307, the edge characteristics may be sufficient for the particular application, wherein the method may proceed directly to step 311 without machining the edges during step 309. As further illustrated in column A, the step of cleaning 315 can also be skipped depending on the particular application. Finally, if the glass sheet is processed in step 306 to produce at least one anti-glare surface, then step 312 can be skipped, or vice versa.

The providing and/or preparing block 301 can further include providing and/or preparing the interlayer (column B). For instance, the method can include the step 317 of providing the interlayer. The interlayer can be provided, by way of non-limiting example, as polyvinyl butyral (PVB) or a SentryGlas® ionomer interlayer although other interlayer types may be provided in further examples as discussed above. In one embodiment, the interlayer can comprise PVB with a thickness ranging from about 0.1 mm to about 0.8 mm, such as from about 0.3 mm to about 0.76 mm. In another embodiment, the interlayer can comprise SentryGlas® ionomer with a thickness ranging from about 0.1 mm to about 2 mm, such as from about 0.5 mm to about 1.5 mm.

In various embodiments, the method can continue to step 319 of cutting the interlayer to the appropriate size for the laminated structure. Still further, the interlayer may be conditioned, for example, to control the moisture content of the interlayer. In one example, the step 321 of conditioning adjusts the moisture content of the interlayer to less than about 1%, such as less than or equal to about 0.65%, such as less than or equal to about 0.2%. Controlling the moisture content of the interlayer may be beneficial to help achieve excellent bonding quality of the interlayer during the lamination procedure. In other embodiments, if the interlayer comprises PVB, the moisture content may be controlled to be less than or equal to about 0.65%. If SentryGlas® ionomer is used, the moisture content may be controlled to be less than or equal to about 0.2%, according to certain embodiments. Controlling the moisture content can be carried out in various ways known in the art. For example, the interlayer may be placed in a controlled environment where the temperature and/or humidity are adjusted to achieve the desired moisture content of the interlayer.

As shown in column B, steps of providing and/or preparing the interlayer may be carried out in different orders and/or certain steps may be omitted altogether. For example, the interlayer may be provided with the appropriate dimensions and properties. In such examples, the steps of cutting 319 and conditioning 321 may be omitted. Furthermore, the step of conditioning may be carried out without the step of cutting or prior to the step of cutting, as shown in FIG. 3.

The providing and/or preparing block 301 can further include providing and/or preparing the metal sheet (column C). The method can begin with step 323 of providing the metal sheet including a first face and a second face with a desired thickness extending between the first face and the second face. In one embodiment, the metal sheet can be provided as a stainless steel metal sheet, although other materials can be used in further embodiments. In another embodiment, the metal sheet may range from a 25 Gauge metal sheet (e.g., about 0.5 mm) up to a 12 Gauge metal sheet (e.g., about 2 mm). In further examples, the thicknesses may range from a 24 Gauge metal sheet (e.g., about 0.64 mm) up to a 16 Gauge metal sheet (e.g., about 1.59 mm). As such, the thickness (see, e.g., T1 in FIG. 1) of the metal sheet can range from about 0.1 mm to about 5 mm, such as from about 0.5 mm to about 2 mm, or from about 0.64 mm to about 1.59 mm, although other thicknesses may be provided depending on the particular application.

The method can further proceed from the step 323 of providing the metal sheet to the step 325 of cutting or otherwise shaping the metal sheet to achieve the desired dimensions and/or shape. In one example, laser cutting may be employed to minimize edge deformation that would otherwise affect bonding quality of the interlay and glass sheet at the edge of the metal sheet. Other suitable cutting mechanisms can be employed, such as a water-jet, for example.

After step 325, the method can optionally proceed to step 327 of edge trimming and cleaning. For example, after the cut, the edge of the stainless steel sheet may be trimmed by a mechanical milling or broaching method, and cleaned with a clean wiper and/or isopropanol or other suitable solvent. The steel surface can also be cleaned with a Teknek (or equivalent) tacky roller to remove surface dust and particulates. The method can then proceed to step 329 of removing any protective film from the steel sheet. For example, when front and/or back protective films are present, they can be removed prior to lamination. As shown, steps 325, 327 and 329 are optional wherein any one of the steps may be omitted and/or the steps may be carried out in various orders as illustrated.

After the glass sheet, interlayer, and metal sheet are provided and/or prepared under the providing/preparing block 301, the method can then proceed to the lamination block 303, including the step of attaching the glass sheet to the first face of the metal sheet with a first interlayer to produce, e.g., the three-layer laminated structure illustrated in FIG. 1. Likewise, the lamination block 303 may also include the step of attaching a second glass sheet to the second face of the metal sheet with a second interlayer to provide a five-layer laminated structure, as illustrated in FIG. 2.

Under the lamination block 303, the method can begin by step 331 of building a stack with the interlayer placed between the glass sheet and the first face of the metal sheet to provide a three-layer stack (see, e.g., FIG. 1). In addition, if desired, the method can continue to build the stack with the second interlayer placed between the second glass sheet and the second face of the metal sheet to provide a five-layer stack (see, e.g., FIG. 2). The stack can then be optionally secured to prevent shifting, for example, by placing pieces of high-temperature polyester tape on at least two edges.

The glass sheet may be attached to the metal sheet using the interlayer by any means known in the art. For instance, the stack can be placed within a vacuum chamber, such as in a vacuum bag. In the step of vacuum bagging, these assembled parts may be wrapped, e.g., in a thin breather cloth which can be secured by tape (e.g., polyester tape), then wrapped in a looser breather material and placed within a plastic film lamination bag. The parts may be arranged in a single layer within the bag, or multiple stacks may be processed at one time for higher throughput. The bag can be heat sealed with a vacuum port attached. The port of the vacuum bag may be attached to a vacuum hose within an autoclave chamber and vacuum may be applied with the chamber still open to check for leaks. Other bagged parts may be loaded as well, up to the part capacity of the autoclave.

In step 333, the vacuum chamber can then be at least partially evacuated and the stack can be heated with a predetermined temperature and pressure profile. For example, the thermal processing step may be carried out with an autoclave wherein specific temperature and pressure profiles are used in order to achieve preferred adhesion (bonding) quality of the laminated structure.

For laminated structures with a PVB interlayer, the parts can be placed under vacuum and subjected to an appropriate temperature and pressure profile. For instance, the temperature may be ramped to the soak temperature of about 130° C. (266° F.) at a rate of approximately 3° F./minute. When the temperature setpoint is reached, a pressure ramp of about 5 psi/minute is initiated until the pressure setpoint of about 80 psi is reached. After a soak time of about 30 minutes, the temperature is ramped back down at a rate of approximately 3° F./minute. Pressure can be held at about 80 psi until the temperature reaches about 50° C. (122° F.) to minimize bubble formation in the PVB, at which point the pressure can also be ramped down at a rate of about 5 psi/minute. After the chamber has cooled and pressure equilibrium is established, the parts can be removed, e.g., from the autoclave, the bagging, and breather cloth, the tape can be removed, and the parts cleaned of lamination residues.

For glass/steel laminates with a SentryGlas® ionomer interlayer, a cycle similar to that detailed above for PVB may be used. For instance, the temperature may be ramped to about 133° C. (272° F.) at a ramp rate of about 4° F./minute. After a soak time of about 60 minutes, the ramp rate can be ramped down at a rate of about 4° F./minute until the temperature reaches 210° F. to minimize haze formation in the film. The laminated structure can then be provided at the end of the process designated by 335 in FIG. 3.

Still further aspects of the disclosure can include optional processing techniques for use during a method of manufacturing the laminated structure that may provide further beneficial features to the laminated structure. For example, processing techniques can optionally include preparation steps for the glass sheet including a scoring and breaking step, edge finishing, ion exchange to apply the compressive surface layer and acid etching to further reduce glass surface flaws. In further embodiments, optional processing techniques can include decoration of the glass or other components to provide the glass with a decorated appearance. For the interlayer, processing techniques can optionally include proper conditioning of the interlayer (e.g., PVB or SentryGlas® ionomer) interlayer to improve bonding strength. For the steel layer, processing techniques can optionally include laser cutting so as to avoid the edge deformation caused by mechanical methods. During the step of lamination, the present disclosure can further include the step of vacuum applied thermal processing with the specific thermal cycling profiles that may be customized for various interlayers (e.g., PVB and SentryGlas® ionomer interlayers), for the purpose of improved bonding strength and reduced air bubbles.

Further optional processing steps may include providing the laminated structures with integrated mounting features, such as holes and/or hooks, which may facilitate installation during end product use. For instance, mounting brackets may be attached to the metal sheet or otherwise provided on the laminated structure. In certain embodiments, the metal sheet may be machined so as to incorporate the holes and/or hooks or any other suitable mounting features.

In another embodiment, the laminated structures may be manufactured so as to reduce or eliminate the occurrence of glass edge contact. Edge contact, especially during the process of handling glass panels, is one of the main causes of glass panel breakage either during installation or use of the laminated structure. In certain cases, edge contact may induce latent defects and/or edge chipping and/or edge cracks on the glass layer. Thus, according to various embodiments disclosed herein, the laminated substrate may be assembled so as to protect the glass edges, e.g., by providing a metal sheet which wraps around the outer edges of the glass sheet. In some embodiments, the glass sheet may be nested inside the recess created by the metal sheet. Other configurations are also envisioned which can reduce the potential for contact with the outer edges of the glass sheet and therefore reduce or avoid the mechanical degradation of the laminated structure.

In various embodiments, an anti-microbial coating can be applied to the surface of the glass sheet. In other embodiments, the glass sheet can include a composition having anti-microbial characteristics. For example, the glass sheet can be a glass or glass ceramic material containing silver, copper or a combination of silver and copper. Exemplary compositions include, but are not limited to, silver and copper, or mixture thereof, which may be zero valent existing in the glass or glass ceramic as Ag⁰ or Cu⁰, which is the metallic form; can be ionic and exist in the glass or glass ceramic as Ag⁺¹, Cu⁺¹ or Cu⁺²; or can be in the glass or glass ceramic as a mixture of the zero valent and ionic forms of one or both agents, for example, Ag⁰ and Cu⁺¹ and/or Cu⁺², Ag⁺¹ and Cu⁰, and other combination of the zero valent and ionic species. The antimicrobial agent can be incorporated into the glass or glass ceramic by, e.g., either (1) ion-exchange of a preformed GC using an ion-exchange bath containing one or both of the foregoing antimicrobial agents, or (2) by including one or both of the foregoing antimicrobial agents into batched materials used to prepare a glass that is then cerammed to form a glass or glass ceramic. In (1), the antimicrobial agent will be present in the glass or glass ceramic in ionic form, as the oxide, since nitrates of the antimicrobial agent can be used for the ion-exchange and because the nitrate species on the glass or glass ceramic are easily decomposed during the ion-exchange process. Additional anti-microbial coatings and compositions are described in International Patent Application Publication No. WO2013/036746, and U.S. application Ser. Nos. 13/649,499; 13/197,312; and 14/176,470, which are incorporated herein by reference in their entireties.

Laminated structures of the present disclosure may have a number of advantages over fully tempered soda lime and stainless steel. For example, laminated structures of the present disclosure may exhibit either comparable or superior performance in terms of impact resistance over fully tempered soda lime mono-layers (as thick as 4 mm). In addition, the laminated structures of the present disclosure may be able to retain glass fragments in place if they break, as compared to fully tempered soda lime which releases glass chips to the surrounding environment if broken. Compared to stainless steel monolithic structures, the presence of a glass layer in the laminated structures of the present disclosure may enable higher structure hardness and therefore higher scratch resistance, and may help maintain the fresh aesthetic look of the steel surface over a longer period of time.

Advantages of some exemplary embodiments of the disclosure can include high quality laminated structures with one or two layers of relatively thin glass (e.g., less than or equal to 2.5 mm). Moreover, by use of various processing techniques for stainless steel laminated applications, the laminated structures may have the ability to maintain the aesthetic look of brushed stainless steel during a longer service time. Moreover, laminated structures of the present disclosure may circumvent typical issues of low impact resistance caused by “localized deformation” that might otherwise occur with other laminate structures with a relatively thin glass layer. In addition, exemplary laminated structures strengthened by acid etching may enable the use of thinner steel like 24 Gauge (0.635 mm) for glass/steel laminates without a substantial adverse effect on impact resistance.

As such, the disclosure further presents laminated structures that can protect a metal sheet with a glass sheet to avoid scratching of the metal sheet and soiling the surface of the glass sheet. Indeed, smudges or dirt that may be more difficult to remove from an unprotected metal surface may be easily removed from the surface of a glass sheet in a convenient manner. In some examples, the glass sheet can be laminated to a stainless steel metal sheet to provide an attractive surface that has enhanced scratch resistance, and is relatively easy to clean, for example, with respect to fingerprints, oil smudges, microbial contaminants, etc. According to various embodiments, the glass sheet may also be treated to provide an anti-glare surface to provide the laminated structure with further aesthetic benefits. The glass sheet can thereby help preserve the aesthetic look of the stainless steel and can help facilitate cleaning and maintenance of the surface of the laminated structure.

Moreover, the glass sheet of the laminated structure can provide the stainless steel metal sheet with increased resistance to plastic deformation under sharp impact. As such, the glass sheet may help to shield the metal sheet from impacts that may otherwise dent or damage the metal sheet. The glass sheet may also increase the chemical/electrochemical stability of the laminated structure as compared to a stainless steel metal sheet, thereby preserving the surface characteristics of the stainless steel.

Furthermore, the glass/metal laminates disclosed herein can be used to produce large-scale (e.g., 300 mm×300 mm or greater) decorative or functional elements with reduced warping and, in some embodiments, no warping, which can meet strict international standards for, e.g., household appliances and architectural elements. Without wishing to be bound by theory, it is believed that the glass/metal laminates disclosed herein have a reduced CTE mismatch between the glass and metal materials, which can prevent or substantially prevent warping, to produce a substantially flat or planar laminate useful in a wide variety of applications.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a glass sheet” includes examples having two or more such glass sheets unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a structure that comprises A+B+C include embodiments where a structure consists of A+B+C and embodiments where a structure consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Example is intended to be non-restrictive and illustrative only, with the scope of the invention being defined by the claims.

### Example

Three glass/metal laminates (34″×55″) were prepared using the materials set forth in Table I below.

TABLE I

| Laminate | Metal | Glass | Interlayer |
|---|---|---|---|
| A | 24 gauge | 1.5 mm | 0.89 mm |
| | 304# stainless | Corning ® Gorilla ® | SentryGlas ® |
| | steel | | |
| B | 26 gauge | 1.5 mm | 0.89 mm |
| | 430# stainless | Corning ® Gorilla ® | SentryGlas ® |
| | steel | | |
| C | 26 gauge | 1.5 mm | 0.76 mm |
| | 430# stainless | Corning ® Gorilla ® | PVB |
| | steel | | |

Laminated structure A comprises 304# stainless steel, which has a CTE of approximately 17×10⁻⁶/° C. Laminated structures B and C comprise 430# stainless steel, which has a CTE of approximately 10.4×10⁻⁶/° C. The Corning® Gorilla® glass sheet used in laminated structures A-C had a CTE of approximately 8.5×10⁻⁶/° C. Accordingly, laminate A falls outside of the scope of the disclosure (CTE of the metal sheet >30% CTE of the glass sheet), whereas laminates B and C fall within the scope of the disclosure (within 30% of the CTE of the glass sheet).

A theoretical analysis of comparative laminate A predicted that warping could be as high as 58 mm. The actual warp of each of the laminates A-C was also measured. Whereas laminate A had an actual warp of 38 mm, which is not acceptable for various applications, laminates B and C had a significantly lower warp of 2 mm. Without wishing to be bound by theory, it is believed that the reduced warp in laminated structures B and C is related to the reduced CTE mismatch between the glass and metal sheets.

What is claimed is:

1. A laminated structure comprising:
a metal sheet having a first face and a second face with a thickness extending between the first face and the second face ranging from about 0.1 mm to about 5 mm;
a first glass sheet having a thickness ranging from about 0.1 mm to about 2.5 mm; and
a first interlayer attaching the first glass sheet to the first face of the metal sheet,
wherein the metal sheet has a coefficient of thermal expansion that is within about 30% of a coefficient of thermal expansion of the glass sheet.

2. The laminated structure of claim 1, wherein the first interlayer comprises a layer of polyvinyl butyral or an ionomer.

3. The laminated structure of claim 2, wherein the layer of polyvinyl butyral has a thickness ranging from about 0.1 mm to about 0.8 mm.

4. The laminated structure of claim 2, wherein the layer of ionomer has a thickness ranging from about 0.1 mm to about 2 mm.

5. The laminated structure of claim 1, wherein the Young's modulus of the first interlayer is greater than or equal to about 15 MPa.

6. The laminated structure of claim 1, wherein first interlayer comprises a Young's modulus of about 275 MPa or greater.

7. The laminated structure of claim 1, wherein the first glass sheet comprises an acid-etched glass sheet.

8. The laminated structure of claim 1, wherein the first glass sheet has a thickness ranging from about 0.3 mm to about 1.5 mm.

9. The laminated structure of claim 1, wherein the first glass sheet is chemically strengthened and/or thermally tempered.

10. The laminated structure of claim 1, wherein the first glass sheet comprises at least one anti-glare surface and/or at least one anti-microbial surface.

11. The laminated structure of claim 1, wherein the coefficient of thermal expansion of the metal sheet ranges from about 7.5×10⁻⁶/° C. to about 11×10⁻⁶/° C.

12. The laminated structure of claim 1, further comprising:
a second glass sheet having a thickness ranging from about 0.1 mm to about 2.5 mm; and
a second interlayer attaching the second glass sheet to the second face of the metal sheet,
wherein the second glass sheet is optionally chemically strengthened.

13. The laminated structure of claim 1, wherein the laminated structure comprises at least one length or width dimension greater than about 300 mm.

14. A method of manufacturing a laminated structure comprising:
(i) providing a metal sheet having a first face and a second face with a thickness extending between the first face and the second face ranging from about 0.1 mm to about 5 mm;
(ii) providing a glass sheet having a thickness ranging from about 0.1 mm to about 2.5 mm; and
(iii) attaching the glass sheet to the first face of the metal sheet with a first interlayer,
wherein the metal sheet has a coefficient of thermal expansion that is within about 30% of a coefficient of thermal expansion of the glass sheet.

15. The method of claim 14, further comprising the step of treating the glass sheet to produce at least one anti-glare surface, wherein the treating step is chosen from acid etching, creamy etching, masked acid etching, sol-gel processing, mechanical roughening, and combinations thereof.

16. The method of claim 14, further comprising a step of strengthening the glass sheet, wherein the strengthening step is chosen from acid etching, chemical strengthening, thermal tempering, and combinations thereof.

17. The method of claim 14, wherein the glass sheet has a thickness ranging from about 0.3 mm to about 1.5 mm.

18. The method of claim 14, wherein the glass sheet comprises at least one anti-glare and/or at least one anti-microbial surface.

19. The method of claim 14, wherein the first interlayer comprises a layer of polyvinyl butyral or an ionomer.

20. The method of claim 14, wherein the coefficient of thermal expansion of the metal sheet ranges from about 7.5×10⁻⁶/° C. to about 11×10⁻⁶/° C.
